(19) United States
(12) Patent Application Publication
(10) Pub. No.: US 2007/0120775 A1
(43) Pub. Date: May 31, 2007

(54) Microcontroller for driving vacuum fluorescent display

(75) Inventors: Kensaku Fukumoto, Kyoto (JP); Katsuhiro Jomatsu, Osaka (JP); Shinsuke Kouno, Osaka (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/604,696

(22) Filed: Nov. 28, 2006

(30) Foreign Application Priority Data
Nov. 28, 2005 (JP) 2005-341303

(51) Int. Cl. G09G 3/22

(52) U.S. Cl. 345/75.1

(57) ABSTRACT

A digit waveform control circuit shifts in time, based on the setting of a digit time shift register, digit scan display data sequentially outputted from a display output control circuit such that digit driving signals are simultaneously outputted from digit driving terminals (high breakdown voltage output terminals for digit display data) connected in parallel outside a microcontroller.

### FIELD OF THE INVENTION

The present invention relates to a microcontroller for driving a vacuum fluorescent display (VFD), the microcontroller directly driving the vacuum fluorescent display.

### BACKGROUND OF THE INVENTION

Currently an increasing number of colors are displayed on vacuum fluorescent displays. Accordingly, when a vacuum fluorescent display is directly driven by a microcontroller for driving the vacuum fluorescent display, the digit current capability becomes insufficient in some cases.

Conventionally, in order to solve this problem, the following method has been used: special hardware that is capable of randomly outputting digit data and called the universal grid function is installed and digit driving signals are simultaneously outputted from digit driving terminals connected in parallel, thereby compensating for the current capability.

For example, Japanese Patent Laid-Open No. 2002-40991 discloses a microcontroller for driving a vacuum fluorescent display. The microcontroller sets digit data in a part of a RAM area beforehand, reads the digit data from the RAM area with the universal grid function when sequentially scanning digits, transfers the read digit data simultaneously to digit driving terminals connected in parallel, and outputs digit driving signals simultaneously from the digit driving terminals connected in parallel.

However, in the conventional microcontroller for driving a vacuum fluorescent display, digit data is set in a part of a RAM area beforehand, and thus additional RAM area for display is necessary to set digit data. Further, the conventional microcontroller for driving a vacuum fluorescent display requires a special circuit for reading, when sequentially scanning digits, the digit data from the RAM area for display, and transferring the read digit data simultaneously to the digit driving terminals connected in parallel. Therefore, in the conventional microcontroller for driving a vacuum fluorescent display, the circuit size and the cost of chips are increased. Moreover, in the conventional microcontroller for driving a vacuum fluorescent display, the digit data has to be set beforehand in the RAM area for display by software, increasing the burden of a software developer.

### DISCLOSURE OF THE INVENTION

An object of the present invention is to provide a microcontroller for driving a vacuum fluorescent display, the microcontroller being capable of easily driving, with a small number of hardware configurations, digit driving terminals in parallel without placing a load on software.

In order to attain the object, a microcontroller for driving a vacuum fluorescent display according to the present invention comprises a plurality of terminals fed with digit data to output digit driving signals to the vacuum fluorescent display, a display output control circuit for sequentially outputting the digit data, a register for storing a register value for shifting the digit data in time, and a digit waveform control circuit for shifting in time, based on the register value of the register, the digit data outputted from the display output control circuit and outputting the digit data, wherein the digit data outputted from the digit waveform control circuit is inputted to the terminals.

A microcontroller for driving a vacuum fluorescent display according to the present invention comprises a plurality of terminals fed with digit data to output digit driving signals to the vacuum fluorescent display, a display output control circuit for sequentially outputting the digit data, a register for storing a register value for holding the digit data for a predetermined period, and a digit waveform control circuit for holding, based on the register value of the register for the predetermined period, the digit data outputted from the display output control circuit and outputting the digit data for the holding period, wherein the digit data outputted from the digit waveform control circuit is inputted to the terminals.

A microcontroller for driving a vacuum fluorescent display according to the present invention comprises a plurality of terminals fed with digit data to output digit driving signals to the vacuum fluorescent display, a display output control circuit for sequentially outputting the digit data, a register for storing a register value for holding the digit data for a predetermined period, and a plurality of selector circuits for selecting the digit data outputted from the display output control circuit, holding the selected digit data based on the register value of the register for the predetermined period, and outputting the digit data for the holding period, wherein the digit data outputted from the selector circuits is inputted to the terminals.

According to the present invention, it is possible to easily drive, with a small number of hardware configurations (a small circuit size), the digit driving terminals in parallel without placing a load on software. In other words, the digit driving terminals can be driven in parallel by setting the register with software. Thus it is not necessary to have a RAM space for digit data, increasing a RAM space freely used for the design of software. Further, it is not necessary to set digit data beforehand in a RAM area, reducing the complexity in the development of the design of software, accordingly. Moreover, it is not necessary to provide a universal grid circuit for simultaneously transferring digit data to the digit driving terminals connected in parallel, reducing the circuit size and the cost of chips.

### BRIEF DESCRIPTION OF THE DRAWINGS

FIG. 1 is a block diagram showing an example of the schematic configuration of a microcontroller for driving a vacuum fluorescent display according to Embodiment 1 of the present invention;

FIG. 2 is a block diagram showing the outline of a configuration in which the digit driving terminals of the microcontroller for driving a vacuum fluorescent display are connected in parallel according to Embodiment 1 of the present invention;

FIG. 3 is a timing chart showing an example of the operation of the microcontroller for driving a vacuum fluorescent display according to Embodiment 1 of the present invention;

FIG. 4 is a timing chart showing the operation of a conventional microcontroller for driving a vacuum fluorescent display;

FIG. 5 is a block diagram showing an example of the schematic configuration of a microcontroller for driving a vacuum fluorescent display according to Embodiment 2 of the present invention;

FIG. 6 is a timing chart showing an example of the operation of the microcontroller for driving a vacuum fluorescent display according to Embodiment 2 of the present invention; and

FIG. 7 is a block diagram showing an example of the schematic configuration of a microcontroller for driving a vacuum fluorescent display according to Embodiment 3 of the present invention.

### DESCRIPTION OF THE EMBODIMENTS

### Embodiment 1

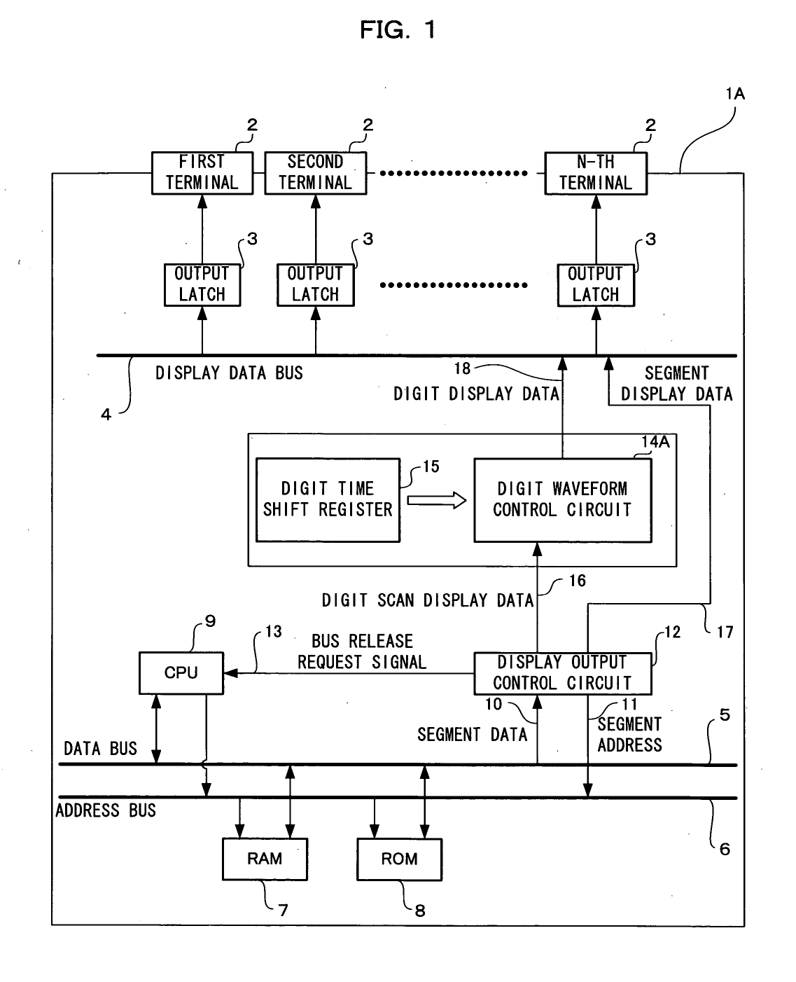

A microcontroller for driving a vacuum fluorescent display according to Embodiment 1 of the present invention will now be described with reference to the accompanying drawings. FIG. 1 shows an example of the schematic configuration of the microcontroller for driving a vacuum fluorescent display according to Embodiment 1.

In FIG. 1, reference numeral 1A denotes a microcontroller for driving a vacuum fluorescent display and reference numeral 2 denotes a plurality of high breakdown voltage output terminals for driving a vacuum fluorescent display (VFD, not shown). The high breakdown voltage output terminals 2 are divided into high breakdown voltage output terminals for digit display data and high breakdown voltage output terminals for segment display data. Hereinafter, the high breakdown voltage output terminal for digit display data is referred to as a digit driving terminal and the high breakdown voltage output terminal for segment display data is referred to as a segment driving terminal.

The digit driving terminal inputs digit display data that is digit data shifted in time by a digit waveform control circuit (described later). After that, the digit driving terminal converts the inputted digit display data to a high-voltage signal for driving the vacuum fluorescent display, and outputs the signal as a digit driving signal.

On the other hand, the segment driving terminal inputs segment display data that is segment data outputted from a display output control circuit (described later). After that, the segment driving terminal converts the inputted segment display data to a high-voltage signal for driving the vacuum fluorescent display, and outputs the signal as a segment driving signal.

In FIG. 1, reference numeral 3 denotes output latches. The output latches 3 latch one of the digit display data and the segment display data according to the timing of display. After that, the output latches 3 output one of the latched digit display data and segment display data to the high breakdown voltage output terminals 2.

In FIG. 1, reference numeral 4 denotes a first data bus (hereinafter, referred to as a display data bus). The display data bus 4 transmits the digit display data and the segment display data to the output latches 3.

In FIG. 1, reference numeral 5 denotes a second data bus, reference numeral 6 denotes an address bus, reference numeral 7 denotes RAM where data can be arbitrarily set, and reference numeral 8 denotes ROM for storing programs. The RAM 7 and the ROM 8 are both connected to the second data bus 5 and the address bus 6.

In FIG. 1, reference numeral 9 denotes a CPU. The CPU 9 is connected to the second data bus 5 and the address bus 6. The CPU 9 stores segment display data, which is segment data, on a predetermined position of the RAM 7 based on a program stored in the ROM 8.

In FIG. 1, reference numeral 10 denotes a first data line, reference numeral 11 denotes an address line, reference numeral 12 denotes a display output control circuit, and reference numeral 13 denotes a bus release request signal line. The first data line 10 connects the second data bus 5 with the display output control circuit 12, and the address line 11 connects the address bus 6 with the display output control circuit 12.

The display output control circuit 12 has the function of designating the address of the RAM 7 through the address line 11 and the address bus 6, reading the segment display data of the designated address through the second data bus 5 and the first data line 10 and outputting the segment display data, the function of generating digit scan display data that is digit data and sequentially outputting the data, and the function of outputting a bus release request signal to the CPU 9.

The bus release request signal line 13 transmits to the CPU 9 the bus release request signal outputted from the display output control circuit 12. The CPU 9 releases the second data bus 5 and the address bus 6 to the display output control circuit 12 in response to the bus release request signal. Thus the display output control circuit 12 can freely access the RAM 7.

Further, in FIG. 1, reference numeral 14A denotes a digit waveform control circuit, reference numeral 15 denotes a digit time shift register, and reference numeral 16 denotes a second data line. The second data line 16 transmits, to the digit waveform control circuit 14A, digit scan display data outputted from the display output control circuit 12.

The digit waveform control circuit 14A shifts in time the digit scan display data outputted from the display output control circuit 12 based on the register value of the digit time shift register 15, and outputs the digit scan display data as digit display data.

The digit time shift register 15 stores the register value for controlling the time-shifting operation of the digit waveform control circuit 14A such that digit driving signals are simultaneously outputted from the plurality of digit driving terminals connected in parallel outside the microcontroller.

In FIG. 1, reference numeral 17 denotes a third data line. The third data line 17 transmits, to the display data bus 4, segment display data outputted from the display output control circuit 12.

In FIG. 1, reference numeral 18 denotes a fourth data line. The fourth data line 18 transmits, to the display data bus 4, digit display data outputted from the digit waveform control circuit 14A.

The following will describe the operation of the microcontroller 1A configured thus for driving a vacuum fluorescent display. First, the display output control circuit 12 outputs the bus release request signal to the CPU 9 and sequentially reads segment display data from the RAM 7. The segment display data read from the RAM 7 by the display output control circuit 12 is outputted to the segment driving terminals through the output latches 3.

On the other hand, the display output control circuit 12 generates the digit scan display data and sequentially outputs the data to the digit waveform control circuit 14A. The digit waveform control circuit 14A shifts in time the digit scan display data based on the contents of the register value set in the digit time shift register 15 such that the digit driving signals are simultaneously outputted from the plurality of digit driving terminals connected in parallel outside the microcontroller, and the digit waveform control circuit 14A outputs multiple pieces of digit display data in one unit of time. The digit display data is outputted to the digit driving terminals through the output latches 3. Thus the digit driving terminals can be driven in parallel. The latch timing of the output latches 3 for latching the segment display data has to be synchronized with the operation timing of the digit driving terminals that are fed with the time-shifted digit display data and driven in parallel.

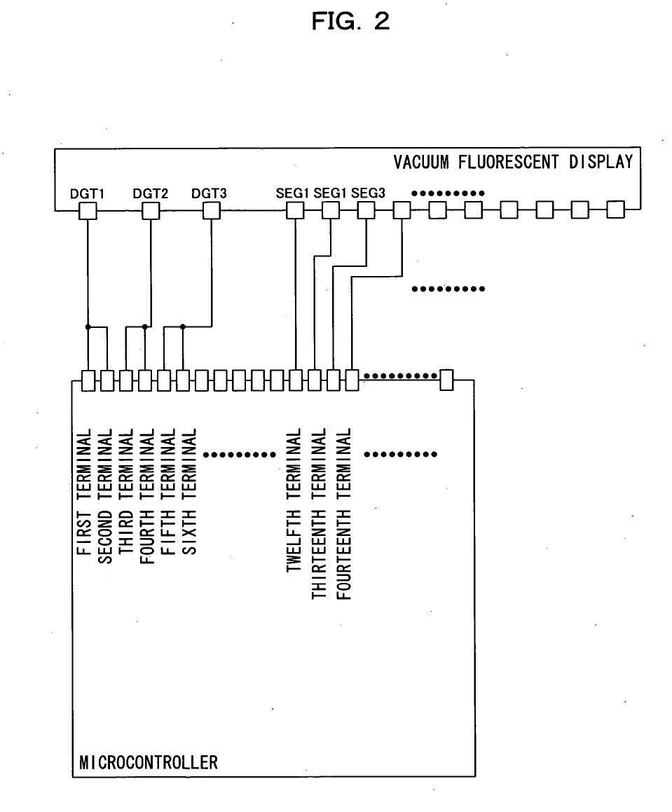

FIG. 2 shows the outline of the configuration of the digit driving terminals connected in parallel. When the microcontroller for driving a vacuum fluorescent display has low digit current capability, two adjacent digit driving terminals are, for example, connected outside the microcontroller for driving a vacuum fluorescent display and driven in parallel as shown in FIG. 2, thereby providing digit current capability satisfying the specification of a vacuum fluorescent display.

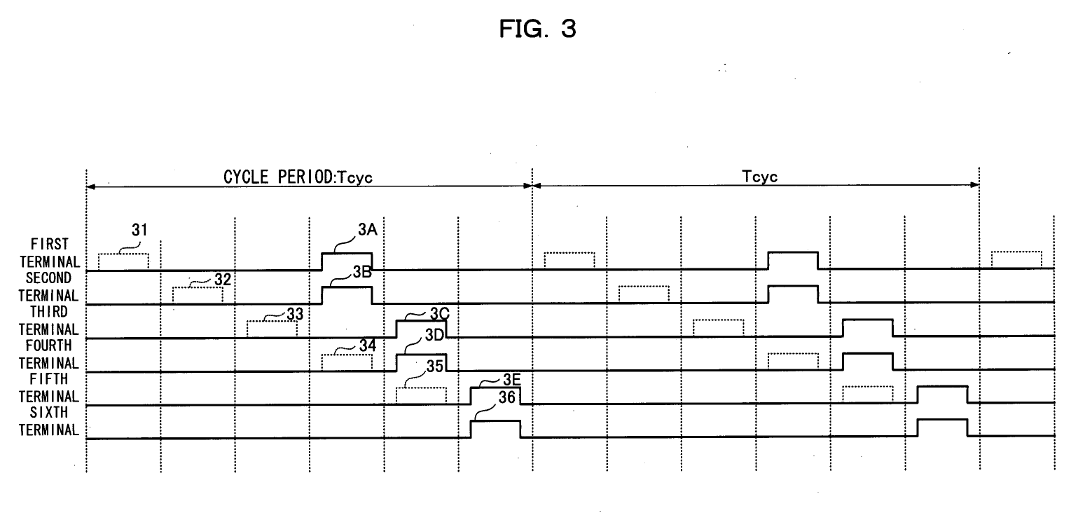

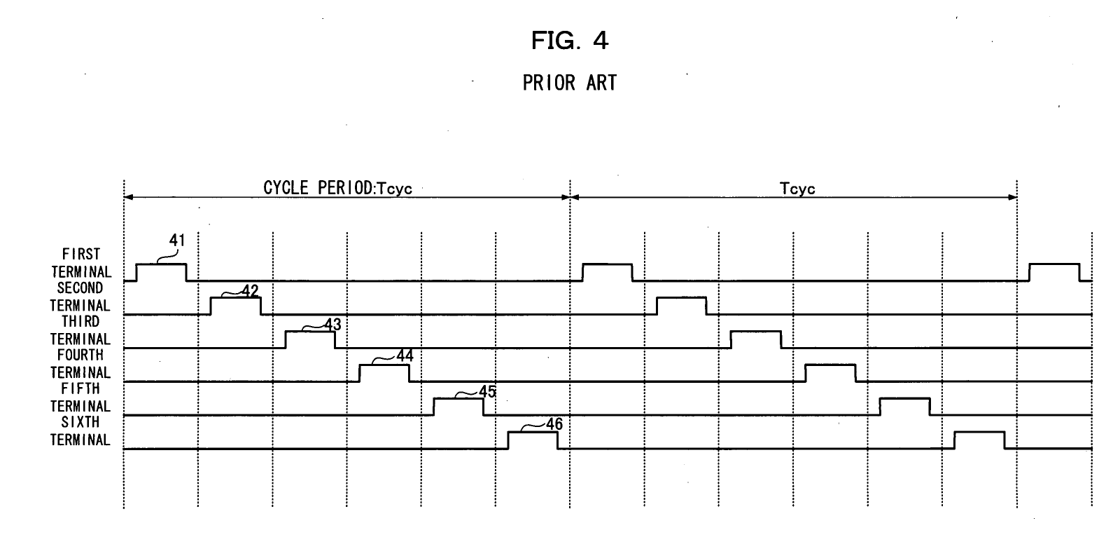

The following will describe a specific example of the time shift of the digit waveform control circuit 14A. FIG. 3 is a timing chart showing an example of the operation of the microcontroller 1A for driving a vacuum fluorescent display. FIG. 4 is a standard timing chart showing that digit display data is not shifted in time.

In FIG. 4, reference numerals 41 to 46 denote the digit display data of first to sixth terminals (digit driving terminals). When the digit display data is not shifted in time, digits 1 to 6 are sequentially displayed per unit time.

In FIG. 3, reference numerals 31 to 36 denote digit scan display data. The digit scan display data 31 to 36 correspond to the digit display data 41 to 46 of FIG. 4. Reference numerals 3A to 3E and 36 denote the digit display data for the first to sixth terminals (digit driving terminals). The time shift operation of the digit waveform control circuit 14A shifts the digit scan display data 31 to 36 in time to the digit display data 3A to 3E and 36.

FIG. 3 shows two-digit parallel driving, that is, digit display data simultaneously inputted to the first and second terminals, the third and fourth terminals, and the fifth and sixth terminals.

To be specific, as shown in FIG. 3, the digit scan display data 31 for the first terminal is shifted by three units of time to the digit display data 3A by the digit waveform control circuit 14A, and the digit scan display data 32 for the second terminal is shifted by two units of time to the digit display data 3B by the digit waveform control circuit 14A, so that the digit display data is simultaneously inputted to the first and second terminals.

Similarly, the digit scan display data 33 for the third terminal is shifted by two units of time to the digit display data 3C by the digit waveform control circuit 14A, and the digit scan display data 34 for the fourth terminal is shifted by one unit of time to the digit display data 3D by the digit waveform control circuit 14A, so that the digit display data is simultaneously inputted to the third and fourth terminals. Similarly, the digit scan display data 35 for the fifth terminal is shifted by one unit of time to the digit display data 3E by the digit waveform control circuit 14A, and the digit scan display data 36 for the sixth terminal is outputted as it is from the digit waveform control circuit 14A, so that the digit display data is simultaneously inputted to the fifth and sixth terminals.

In this way, it is possible to simultaneously input the digit display data to the adjacent two digit driving terminals and simultaneously output the digit driving signals from the adjacent digit driving terminals.

As shown in FIG. 3, in the case of two-digit parallel driving, display with a cycle period of Tcyc/2 can be provided relative to a cycle period Tcyc of the digit display data and the digit scan display data. Not only two-digit parallel driving but also n-digit parallel driving can be performed. In n-digit parallel driving, display with a cycle period of Tcyc/n is possible.

### Embodiment 2

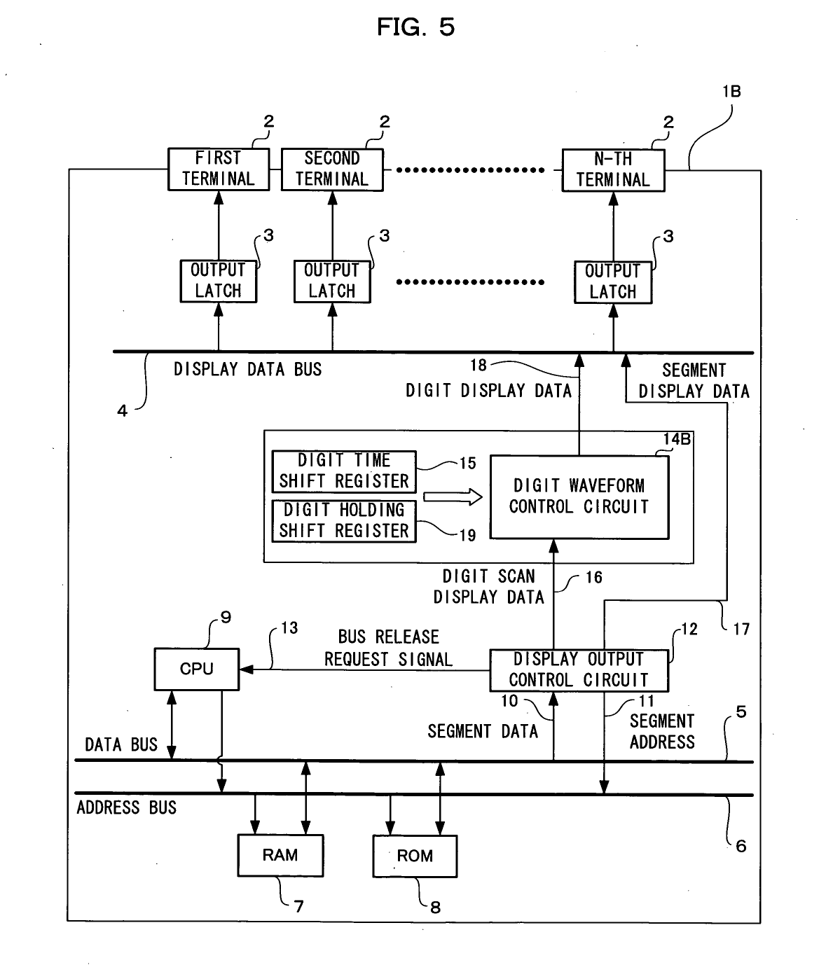

A microcontroller for driving a vacuum fluorescent display according to Embodiment 2 of the present invention will now be described with reference to the accompanying drawings. FIG. 5 shows an example of the schematic configuration of the microcontroller for driving a vacuum fluorescent display according to Embodiment 2. The same members as those of Embodiment 1 are indicated by the same reference numerals and the explanation thereof is omitted.

In Embodiment 2, a digit holding shift register is added to the control elements of the digit waveform control circuit of Embodiment 1.

In FIG. 5, reference numeral 19 denotes a digit holding shift register. A digit waveform control circuit 14B holds, based on the register value of the digit holding shift register 19 for a predetermined period, digit scan display data outputted from a display output control circuit 12 and outputs the digit scan display data as digit display data during the holding period.

The digit holding shift register 19 stores the register value for controlling the holding/shifting operation of the digit waveform control circuit 14B such that digit driving signals are outputted from digit driving terminals for a predetermined period.

The following will describe the operation of a microcontroller 1B configured thus for driving a vacuum fluorescent display. First, as in Embodiment 1, the display output control circuit 12 outputs a bus release request signal to a CPU 9 and sequentially reads segment display data from RAM 7. The segment display data read from the RAM 7 by the display output control circuit 12 is outputted to segment driving terminals through output latches 3.

On the other hand, as in Embodiment 1, the display output control circuit 12 generates digit scan display data and sequentially outputs the data to the digit waveform control circuit 14B. The digit waveform control circuit 14B holds the digit scan display data for a predetermined period based on the contents of the register value set in the digit holding shift register 19 such that the digit driving signals are simultaneously outputted from a plurality of digit driving terminals connected in parallel outside the microcontroller, and the digit waveform control circuit 14B outputs multiple pieces of digit display data in one unit of time. The digit display data is outputted to the digit driving terminals through the output latches 3. Thus the digit driving terminals can be driven in parallel. The latch timing of the output latches 3 for latching the segment display data has to be synchronized with the operation timing of the digit driving terminals that are fed with the held and shifted digit display data and driven in parallel.

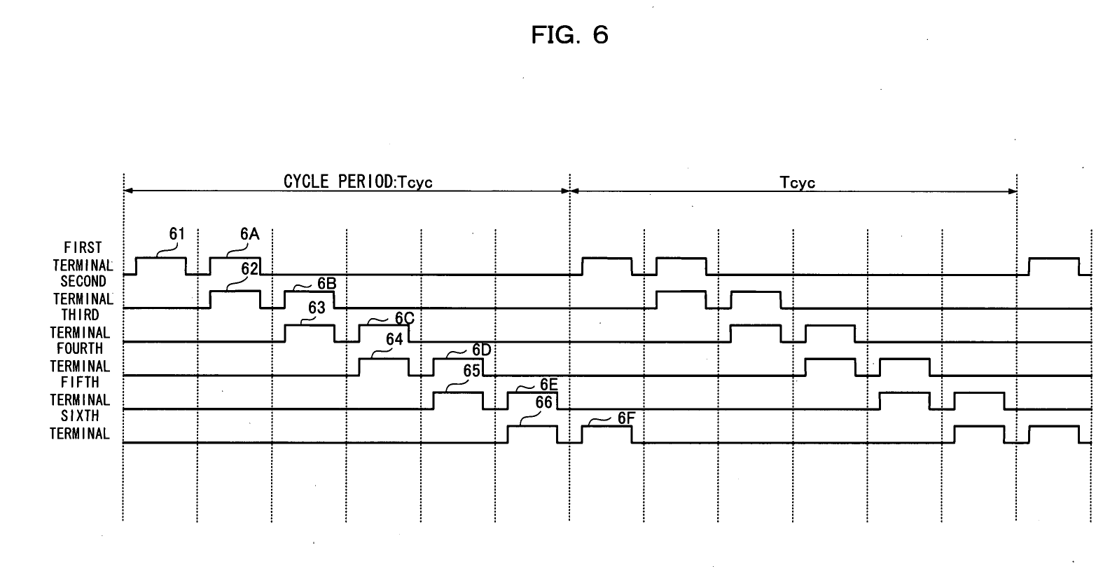

The following will describe a specific example of the holding and shifting operation of the digit waveform control circuit 14B. FIG. 6 is a timing chart showing an example of the operation of the microcontroller 1B for driving a vacuum fluorescent display.

In FIG. 6, reference numerals 61 to 66 denote digit display data for first to sixth terminals (digit driving terminals) The digit display data 61 to 66 correspond to the digit display data 41 to 46 of FIG. 4. Further, in FIG. 6, reference numerals 6A to 6F denote held and shifted digit display data. The digit display data 61 to 66 are held by the digit waveform control circuit 14B for one unit of time (one digit) and shifted to the digit display data 6A to 6F.

FIG. 6 shows two-digit parallel driving, that is, digit display data simultaneously inputted to the first and second terminals, the second and third terminals, the third and fourth terminals, the fourth and fifth terminals, the fifth and sixth terminals, and the sixth and first terminals.

To be specific, as shown in FIG. 6, the digit scan display data 61 for the first terminal is held by the digit waveform control circuit 14B for one unit of time, and the digit display data 6A is inputted to the first terminal concurrently with the input of the digit display data 62 to the second terminal, so that the digit display data is simultaneously inputted to the first and second terminals.

Similarly, for example, the digit display data 62 for the second terminal is held by the digit waveform control circuit 14B for one unit of time, and the digit display data 6B is inputted to the second terminal concurrently with the input of the digit display data 63 to the third terminal, so that the digit display data is simultaneously inputted to the second and third terminals.

Also at the end of a cycle period Tcyc of the digit display data and the digit scan display data, the digit display data 66 for the sixth terminal is held by the digit waveform control circuit 14B for one unit of time and the digit display data 6F is inputted to the sixth terminal concurrently with the input of the digit display data to the first terminal, so that the digit display data is simultaneously inputted to the sixth and first terminals.

In this way, it is possible to simultaneously input the digit display data to the adjacent two digit driving terminals and simultaneously output the digit driving signals from the adjacent digit driving terminals.

In the above explanation, there has been described the case where the digit display data is held for one unit of time (one digit). The holding time is not limited to one unit of time and the digit display data can be held for n units of time (n digits).

By increasing the holding time, the digit driving signals are sequentially outputted from the terminals for a longer time and the number of digit driving signals simultaneously outputted in one unit of time increases.

Further, the digit waveform control circuit 14B also has the function of the digit waveform control circuit 14A described in Embodiment 1. The combination of the digit time shift register 15 and the digit holding shift register 19 can facilitate desired digit display only by setting the registers.

### Embodiment 3

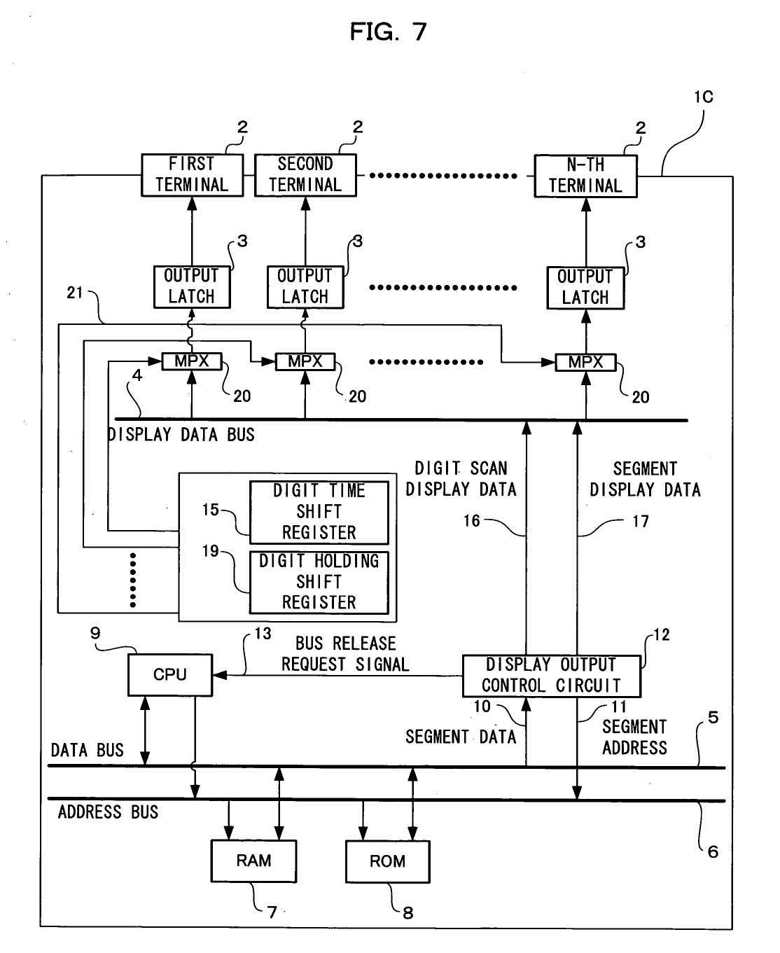

A microcontroller for driving a vacuum fluorescent display according to Embodiment 3 of the present invention will now be described with reference to the accompanying drawings. FIG. 7 shows an example of the schematic configuration of the microcontroller for driving a vacuum fluorescent display according to Embodiment 3. The same members as those of Embodiments 1 and 2 are indicated by the same reference numerals and the explanation thereof is omitted.

In FIG. 7, reference numeral 20 denotes multiplexers (MPX) acting as selector circuits. The multiplexer 20 is provided for each output latch 3. In Embodiment 3, a second data line 16 transmits, to a display data bus 4, digit scan display data outputted from a display output control circuit 12. The display data bus 4 transmits the digit scan display data and the segment display data to the multiplexers 20.

These multiplexers 20 are divided into multiplexers for digit display data and multiplexers for segment display data. The multiplexer 20 for digit display data has the function of selecting the digit scan display data transmitted to the display data bus 4, shifting in time the selected digit scan display data based on the contents of the register value of a digit time shift register 15, and outputting the data, and the function of holding the selected digit scan display data based on the contents of the register value of a digit holding shift register 19 for a predetermined period and outputting the data for the holding period.

On the other hand, the multiplexer 20 for segment display data has the function of selecting the segment display data transmitted to the display data bus 4 and outputting the selected segment display data to the output latches 3 according to the operation timing of digit driving terminals that are fed with digit display data time-shifted based on the contents of the register value of the digit time shift register 15 and are driven in parallel, and the function of outputting the selected segment display data to the output latches 3 according to the operation timing of digit driving terminals that are fed with digit display data held and shifted based on the contents of the register value of the digit holding shift register 19 and are driven in parallel.

In FIG. 7, reference numeral 21 denotes a fifth data line. The fifth data line 21 transmits a signal reflecting the register value of one of the digit time shift register 15 and the digit holding shift register 19 to the multiplexers 20.

As described above, in Embodiment 3, the multiplexer for digit display data is caused to have the same functions as those of the digit waveform control circuits 14A and 14B described in Embodiments 1 and 2, and the operation of a microcontroller 1C for driving a vacuum fluorescent display according to Embodiment 3 is similar to those of the microcontrollers 1A and 1B for driving a vacuum fluorescent display according to Embodiments 1 and 2.

To be specific, first, the display output control circuit 12 outputs a bus release request signal to a CPU 9 and sequentially reads segment display data from RAM 7. When the signal reflecting the contents of the digit time shift register 15 is transmitted through the fifth data line 21, the segment display data read from the RAM 7 by the display output control circuit 12 is selected by the multiplexers 20 for segment display data, outputted from the multiplexers 20 based on the contents of the register value set in the digit time shift register 15, and inputted to the segment driving terminals through the output latches 3.

On the other hand, the display output control circuit 12 generates digit scan display data and sequentially outputs the data to the display data bus 4. The multiplexers 20 for digit display data select the digit scan display data transmitted to the display data bus 4, shift in time the selected digit scan display data based on the contents of the register value set in the digit time shift register 15 such that digit driving signals are simultaneously outputted from the plurality of digit driving terminals connected in parallel outside the microcontroller, and the multiplexers 20 output the data as digit display data.

On the other hand, when the signal reflecting the contents of the digit holding shift register 19 is transmitted through the fifth data line 21, the segment display data read from the RAM 7 by the display output control circuit 12 is selected by the multiplexers 20 for segment display data, outputted from the multiplexers 20 based on the contents of the register value set in the digit holding shift register 19, and inputted to the segment driving terminals through the output latches 3.

The multiplexers 20 for digit display data select the digit scan display data transmitted to the display data bus 4, holds the selected digit scan display data for a predetermined time based on the contents of the register value set in the digit holding shift register 19 such that the digit driving signals are simultaneously outputted from the plurality of digit driving terminals connected in parallel outside the microcontroller, and the multiplexers 20 output the data as digit display data during the holding period.

The digit display data outputted from the multiplexers 20 is outputted to the digit driving terminals through the output latches 3. Thus the digit driving terminals can be driven in parallel.

As described above, according to Embodiment 3, the multiplexer for digit display data is caused to have the same functions as those of digit waveform control circuits 14A and 14B described in Embodiments 1 and 2. Thus the combination of the digit time shift register 15 and the digit holding shift register 19 can facilitate desired digit display only by setting the registers.

The microcontroller for driving a vacuum fluorescent display according to the present invention can easily drive, with a small number of hardware configurations (a small circuit size), the digit driving terminals in parallel without placing a load on software, and thus the present invention is useful for a semiconductor device for driving a vacuum fluorescent display capable of providing a variety of displays.

What is claimed is:

1. A microcontroller for driving a vacuum fluorescent display, comprising:
a plurality of terminals fed with digit data to output digit driving signals to the vacuum fluorescent display,
a display output control circuit for sequentially outputting the digit data,
a register for storing a register value for shifting the digit data in time, and
a digit waveform control circuit for shifting in time, based on the register value of the register, the digit data outputted from the display output control circuit, and outputting the digit data,
wherein the digit data outputted from the digit waveform control circuit is inputted to the terminals.

2. A microcontroller for driving a vacuum fluorescent display, comprising:
a plurality of terminals fed with digit data to output digit driving signals to the vacuum fluorescent display,
a display output control circuit for sequentially outputting the digit data,
a register for storing a register value for holding the digit data for a predetermined period, and
a digit waveform control circuit for holding, based on the register value of the register for the predetermined period, the digit data outputted from the display output control circuit, and outputting the digit data for the holding period,
wherein the digit data outputted from the digit waveform control circuit is inputted to the terminals.

3. A microcontroller for driving a vacuum fluorescent display, comprising:
a plurality of terminals fed with digit data to output digit driving signals to the vacuum fluorescent display,
a display output control circuit for sequentially outputting the digit data,
a register for storing a register value for holding the digit data for a predetermined period, and
a plurality of selector circuits for selecting the digit data outputted from the display output control circuit, holding the selected digit data based on the register value of the register for the predetermined period, and outputting the digit data for the holding period,
wherein the digit data outputted from the selector circuits is inputted to the terminals.
